(19) United States
(12) Patent Application Publication
(10) Pub. No.: US 2009/0205152 A1
(43) Pub. Date: Aug. 20, 2009

(54) Refill for a Cleaning Implement

(76) Inventors: Douglas A. Soller, Racine, WI (US); Jose de Jesus Castillo Higareda, Racine, WI (US); Steven A. Zach, Racine, WI (US); Padma Prabodh Varanasi, Racine, WI (US); Srikanth Pilla, Milwaukee, WI (US); Jose Porchia, Greenfield, WI (US); Jacqueline V. Lepow, Franklin, WI (US); Garsen Lee Yap, Wauwatosa, WI (US); Jason C. Billig, Mount Vernon, NY (US); Stuart M. Leslie, Larchmont, NY (US); Charles A. Curtiss, Norwalk, CT (US)

Correspondence Address: S.C. JOHNSON & SON, INC., 1525 HOWE STREET, RACINE, WI, 53403-2236, US

(21) Appl. No.: 12/225,465

(22) PCT Filed: Mar. 22, 2007
(86) PCT No.: PCT/US2007/007114

§ 371 Date: Apr. 14, 2009

Related U.S. Application Data
(60) Provisional application No. 60/784,540, filed on Mar. 22, 2006.
(60) Provisional application No. 60/844,868, filed on Sep. 15, 2006.

(51) Int. Cl. B08B 1/00

(52) U.S. Cl. 15/104.93

(57) ABSTRACT

A cleaning implement is disclosed which is of the all-in-one type. It has a substrate that delivers impregnated cleaning liquid to the window being cleaned, a squeegee blade to drive used cleaning liquid off the window, and an absorbent region of the substrate to collect the used liquid. In some embodiments a single block of substrate can provide the applicator, scrubbing, and collecting functions, as well as filter and reprocess used cleaning liquid for further use. Refill structures are provided to permit insertion of the refill in varied directions, to facilitate insertion and removal of the refill, to increase the abrasive character of the refill, to minimize drooling, and to otherwise optimize cleaning properties of the refill.

### CROSS-REFERENCE TO RELATED APPLICATIONS

This application claims priority based on U.S. provisional Ser. No. 60/784,540, filed Mar. 22, 2006 and U.S. provisional Ser. No. 60/844,868 filed Sep. 15, 2006.

### STATEMENT REGARDING FEDERALLY SPONSORED RESEARCH/DEVELOPMENT

Not applicable.

### BACKGROUND OF THE INVENTION

The present invention relates to devices for cleaning windows and other hard surfaces. More particularly, it relates to “all-in-one” type devices that deliver a cleaning fluid, work the fluid along the surface being cleaned, squeegee the used liquid off the surface, and collect the used liquid, and particularly to replacement refills for use therewith.

Cleaning of windows and other hard surfaces typically requires several tools and is a multi-step process. One usually picks up a spray bottle and sprays the window, then picks up a sponge or cloth and works the cleaning fluid along the window glass, then picks up a squeegee to drive the used cleaning fluid off the window, then dries the remaining “drool” with a rag or the like. Hence, several devices are required, and additional time is needed to shift from device to device. Moreover, this process may leave wet and soiled paper or rags to be dealt with or disposed of.

There have been attempts to collect liquid as it is being squeegeed off windows or other surfaces, using wicking or absorbent layers adjacent the squeegee blade. Se e.g. U.S. Pat. Nos. 5,970,560, 6,092,255 and 6,668,418. Even when using such devices one will still need to use a separate spray bottle.

While there have been a variety of attempts to incorporate a source of cleaning fluid into a cleaning device (see e.g. U.S. Pat. No. 6,872,021), most of these devices do not provide the capability for collecting the squeegee “drool”. While this is not a serious problem for automobile use, or for other use on the outside of buildings, use on the interior surfaces of building windows can be problematic, particularly where sensitive paint or carpet is located adjacent the window being cleaned.

U.S. Pat. No. 1,376,195 discloses a window cleaning device in which there is a reservoir containing cleaning liquid that impregnates a moistening element/sponge. Adjacent to that is a squeegee which collects the liquid and drives it to an adjacent catch reservoir on the device. Similarly, U.S. Pat. No. 2,722,701 discloses a device which supplies a cleaning liquid, squeegees it off the window, and collects at least some of it in an adjoining absorbent pad region. However, with these devices, once the liquid is used up or the collection capacity of the device exceeded, it is difficult to adapt the device for continued use. Moreover, the devices are not compact and carry unnecessary weight.

While replaceable cartridges have been used in a variety of contexts, to date the art appears deficient with respect to providing a compact, replaceable cartridge that both delivers cleaning fluid and absorbs it.

Hence, there is a continuing need for improved cleaning implements of the all-in-one type, particularly with respect to improved refill units used therewith.

### BRIEF SUMMARY OF THE INVENTION

The present disclosure relates to improvements in a substrate configuration, improved refill assemblies incorporating the substrate, and improved means of mounting and removing such refill assemblies. This disclosure finds particular application to cleaning implements of the type described in U.S. Ser. No. 60/784,740 filed on Mar. 22, 2006 (the disclosure of which is hereby incorporated by reference as if fully set forth herein for further background).

In one aspect the present invention provides a refill for a cleaning implement, the cleaning implement being of a type suitable to clean a hard surface. The refill has a porous substrate impregnated with a cleaning liquid and is suitable to be mounted on the cleaning implement. The substrate has a frontal face with two inset portions and an outwardly extending contact portion there between, such that the refill can present an essentially identical face to the hard surface regardless of whether mounted on the cleaning implement in a first orientation, or in a second orientation upside down from the first orientation.

In a preferred form the substrate also has a back face with two inset portions and an outwardly extending contact portion there between. Thus, the refill can present an essentially identical face to the hard surface regardless of whether mounted on the cleaning implement in the first orientation, or in the second orientation, or in a third orientation front-to-back reversed relative to the first orientation, or in a fourth orientation front-to-back reversed relative to the second orientation.

By using this form of the invention one presents an essentially identical face to the window being cleaned regardless of which of the two (preferably which of the four) most intuitive orientations relative to the surface being cleaned the substrate is inserted into is cartridge holder. This is achieved while still retaining an inset for collecting squeegeed liquid. A particularly preferred configuration to achieve this has a cross shaped cross section.

In another aspect of the invention the substrate may have a frontal face with two lateral inset portions suitable to facilitate gripping of the refill and removal of the refill from the cleaning implement.

In still another aspect the invention there is a refill cartridge for an implement suitable to treat a hard surface. It has a housing and a porous substrate mounted to the housing. The substrate is impregnated with a liquid and the substrate is suitable to deliver the liquid to the surface as well as to collect used liquid. The housing is provided with means to facilitate easy removal of the porous substrate from the housing. In one form this means is a rear opening through the housing such that by passing something through the opening one can facilitate removal of the porous substrate from the housing. In another form it is a strap extending in the housing behind the substrate and also externally of the cartridge, such that pulling on the strap can facilitate removal of the substrate from the housing.

In another aspect the invention provides methods of installing a replaceable cleaning pad on a cleaning implement support. One obtains a replacement cleaning pad that is stored in a flexible package having a removable cover. One then removes the cover of the package so as to create an open-ended package. This is followed by an aligning an open end of the package so created with an attachment recess of the support, and a pushing of a wall of the package inward to drive the replacement cleaning pad out of the package and into the attachment recess. In this manner the replacement cleaning pad can be installed on the support without the need of a human to directly contact the pad. Hence, there is provided a flexible, cup-like package to retain a replacement substrate prior to use, and the use of a flexible bottom wall of that package to help install the replacement substrate in its refill assembly cartridge housing without needing to touch the substrate.

In yet another form the invention provides a cleaning implement for cleaning a surface. There is a support head and a removable refill cartridge mountable to the support head. The refill cartridge has a housing and a porous substrate mounted to the housing. The substrate is impregnated with a liquid and the substrate is suitable to deliver the liquid to the surface as well as to collect used liquid. Also, the support head has a lateral side opening configured such that the refill cartridge can be slid through the opening to mount the cartridge to the support head via a tongue in groove type connection. Hence, it is proposed to provide a tongue-in-groove type connection between a replacement substrate and its cartridge housing, so as to facilitate a side in sliding assembly between the two parts.

In yet another form there is provided a refill for a cleaning implement. The cleaning implement is of a type suitable to clean a hard surface. The refill has a porous substrate impregnated with a cleaning liquid and is suitable to be mounted on the cleaning implement. The substrate has a frontal contact face provided with means on its surface to present an abrasive contact surface. This means can be an array of raised bumps or ribs, or at least one diagonal groove separating two areas of an abrasive contact surface. The diagonal groove, if present, can also assist in helping avoid “drooling” during storage.

In another aspect the invention provides a refill cartridge for an implement suitable to treat a hard surface. The cartridge has a housing, a squeegee blade, and a first substrate mounted to the housing where the first substrate is impregnated with a liquid and the substrate is suitable to deliver the liquid to the surface. There is also a second substrate mounted to the housing, where the second substrate is suitable to absorb used liquid from the surface. In preferred aspects of this version, the first and second substrates are separated by an impermeable barrier, e.g. a barrier which extends essentially vertically as the cleaning implement is used.

Thus, here it is proposed to split the substrate into two, and form the two parts of different materials. One part is optimized for delivering cleaning liquid to the window, and the other is optimized for absorbing dirty cleaning fluid.

In yet another form of the invention there is provided a cleaning implement for cleaning a surface. It has a support head, a squeegee blade supported by the support head, and a removable refill mounted to the support head. The refill has a porous substrate impregnated with a liquid such that the substrate is suitable to deliver the liquid to the surface as well as to collect used liquid. In this form the substrate has an inset portion and an outwardly extending contact surface. The squeegee blade extends farther frontally than the contact surface by at least 0.2 mm but not more than 2 mm, and the squeegee blade extends farther frontally than the rearmost portion of the inset portion by at least 0.5 mm, but not more than 3 mm.

In accordance with this aspect of the invention the squeegee blade extends farther frontally than the contact surface by at least 0.2 mm but not more than 2 mm (most preferably between 0.2 mm and 0.8 mm). Also, the squeegee blade extends farther frontally than the rearmost portion of the inset portion by at least 0.5 mm, but not more than 3 mm (most preferably between 0.8 mm and 1.5 mm).

In further aspects of the invention, there is provided a refill for a cleaning implement. It has a porous substrate impregnated with a cleaning liquid and suitable to be mounted on the cleaning implement, where the substrate has a characteristic selected from the group consisting of a VP Factor of between 3×10⁻⁴ and 16×10⁴, a permeability of between 14 and 55 darcy, a Compressibility of between 0.5 and 18 g/mm², a density of between 0.01 and 25 g/cc, and a porosity of between 60 and 90 percent. These parameters relate to minimizing unwanted drool from the substrate prior to use, avoiding problems in delivering cleaning liquid,

It is desirable to control the permeability of the substrate so that it is between 14.0 and 55 darcy, more preferably between 17 and 50 darcy, even more preferably between 20 and 44 darcy. A “darcy” is a unit of permeability, representing the flow of the test liquid, at 1 atmosphere, of 1 cubic centimeter of test liquid with 1 centipoise viscosity in 1 second through a 1-square-centimeter cross section of a substrate 1 centimeter long.

It is desirable to control the “Compressibility” of the substrate so that it will compress 10 percent when a weight is uniformly spread over its top surface within the following range: 0.5 and 18 grams/mm², most preferably 2 and 15 grams/mm², even more preferably between 3 and 13 grams/mm², where the grams refer to the weight applied, and the mm² refers to the top area on which the weight is applied.

It is desirable to control the porosity of the substrate. The preferred percentage volume of pores in the material (the porosity) is between 60 to 90 percent, more preferably between 70 to 85 percent, most preferably between 79 to 83 percent.

The squeegee blade may be mounted with the substrate in a single replaceable cartridge unit. Alternatively, the squeegee blade can be separately mountable to/anchored on the support head and the substrate can be removable from the support head while the squeegee blade remains on the support head.

Such cleaning implements are most suitable for cleaning building windows. However, they can also be used for cleaning automobile windows and other bard surfaces such as those found in bathing and showering areas or on counter tops. A variety of cleaning liquids can be used ranging from water to specialized window cleaners (e.g. Windex® brand window cleaner), to other hard surface cleaning fluids.

When the substrate is a single piece it is preferably designed to deliver the cleaning fluid to the window, and then also absorb the cleaning fluid back into itself. This form of substrate can also be designed to filter and thus reprocess the cleaning fluid, so that it can then be used again. Hence, the amount of impregnating fluid, and thus the weight of the device, can be kept to a minimum.

Using the present invention, windows and other hard surfaces can be cleaned without the need for a separate spray bottle, or other separate drying cloths or separate squeegees. In addition to cleaning, the liquid impregnating the substrate could also optionally treat the surface in other ways. For example, the liquid could contain polishes, antibacterial treatments and/or insecticides.

The foregoing and other advantages of the invention will become apparent from the following description. In the following description reference is made to the accompanying drawings which form a part thereof, and in which there is shown by way of non-limiting illustration preferred embodiments of the invention.

### BRIEF DESCRIPTION OF THE DRAWINGS

FIG. 1 is a frontal perspective view of a cleaning implement of the present invention;

FIG. 2 is a partial cross sectional view taken along line 2-2 of FIG. 1;

FIG. 3 is an enlarged perspective view of the substrate of FIG. 2, albeit removed from the cleaning implement and from its holder housing;

FIG. 4 is a rear plan view of the FIG. 3 substrate;

FIG. 5 is another embodiment of a substrate which is similar to the FIG. 3 substrate, except that it has a flat rear surface and that its frontal wall is provided with cutouts;

FIG. 6 is a frontal perspective view showing the refill assembly of FIG. 1, removed from the support head;

FIG. 7 is a rear plan view of the FIG. 6 refill assembly;

FIG. 8 is a rear perspective view of the upper portion of the FIG. 1 cleaning implement;

FIG. 9 depicts in schematic form how a substrate of the present invention can be removed from a refill cartridge housing of the present invention through use of a pull strap;

FIG. 10 depicts a preferred flexible package for storing a refill substrate prior to use;

FIG. 11 depicts an alternative means of mounting a FIG. 1 substrate to a modified housing, where the housing has been modified to have a side slide-in slot;

FIG. 12 depicts how the outside contact surfaces of a FIG. 3 substrate could be modified to have raised nub areas to provide a more abrasive structure;

FIG. 13 depicts how an outside contact surface of a FIG. 3 substrate could be modified to be broken into multiple spaced ribs;

FIG. 14 depicts bow an outside contact surface of a FIG. 3 substrate could be modified through the use of diagonal grooves;

FIG. 15 is a partial vertical sectional view through a modified refill assembly where a substrate has been formed as two parts, the parts being made of different materials; and

FIG. 16 is a partial vertical section through yet another modified refill assembly, this version being used to illustrate optimal positioning relationships.

### DETAILED DESCRIPTION OF THE PREFERRED EMBODIMENTS

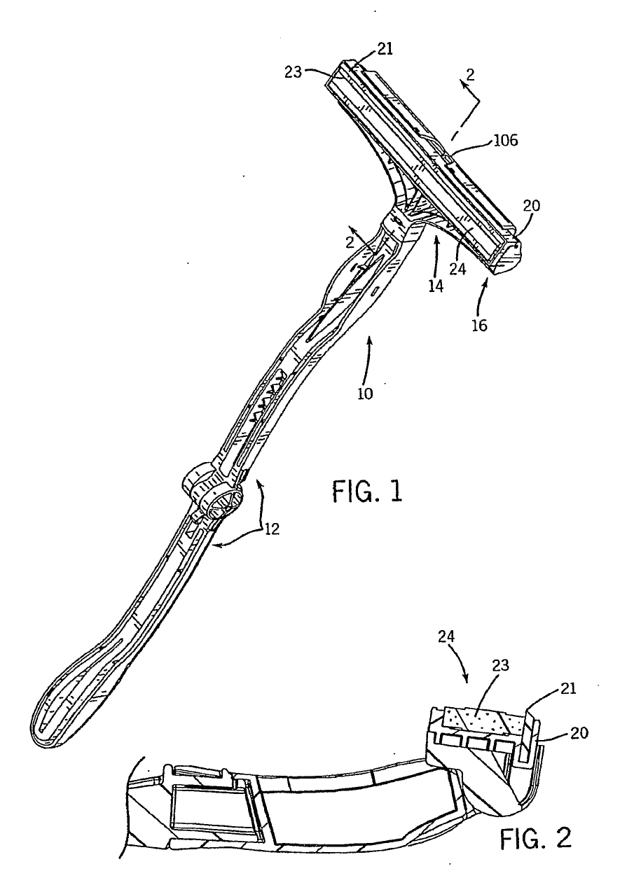

Referring first to FIGS. 1, 2 and 6-8, there is shown a cleaning implement generally 10 having an extendible fold over type handle 12 linked to a support head 14. A replaceable cartridge (generally 16) is mountable on the support head 14. The cartridge 16 has an outer shell 20, a squeegee blade 21 positioned inside and at an upper end of the shell, and an absorbent substrate 24 positioned below the squeegee blade 21 in the shell 20. The substrate 24 is impregnated with a window cleaner.

While not shown, the shell 20 may have radially spaced, inwardly directed, tangs to help catch the substrate as it is installed. Also, the shell 20 may be designed with a projection to snap into a corresponding portion of support head 14.

The substrate is most preferably formed from a synthetic fibrous filtering material selected from the group consisting of polyester fiber, polypropylene fiber, cellulose acetate fiber, and bonded polyolefin fiber. Particularly preferred absorbents are polyester fiber materials, polypropylene fiber materials, cellulose acetate fiber materials, and bonded polyolefin fiber materials available from Filtrona Richmond Inc. (Colonial Heights, Va.) (e.g. BPF or BNW grades). Alternatively, one could use a porous polyethylene or polyvinylacetate material available from Porex, or a cellulosic pad with horizontal capillary fibers made of plastic to improve integrity and water transport. Another possibility is to use a melamine foam.

Various improvements are described as follows. First, substrate 24 is a slab-like structure, albeit cross-like in cross section. This has the advantage of permitting insets 28 to facilitate liquid collection regardless of which of the primary four most intuitive options the consumer chooses for inserting the refill substrate 24 into the shell 20, with the appearance of the substrate to the window being cleaned being essentially identical in all four configurations. Thus, even if the consumer “mistakenly” places the rear face forward, and/or places the substrate upside down, the performance will not be adversely affected. This avoids the need for directional arrows or instructions on or associated with the cleaning implement.

As seen in FIG. 5, the substrate 24A has a flat rear side and may be provided on its lateral frontal ends with cutouts 102 and 103 to facilitate removal. A consumer can place a finger from one hand in cutout 102, and a finger from another hand in cutout 103. By pressing the fingers towards each other and then pulling forward, the substrate 24A can be readily removed from the shell 20 when replacement is desired.

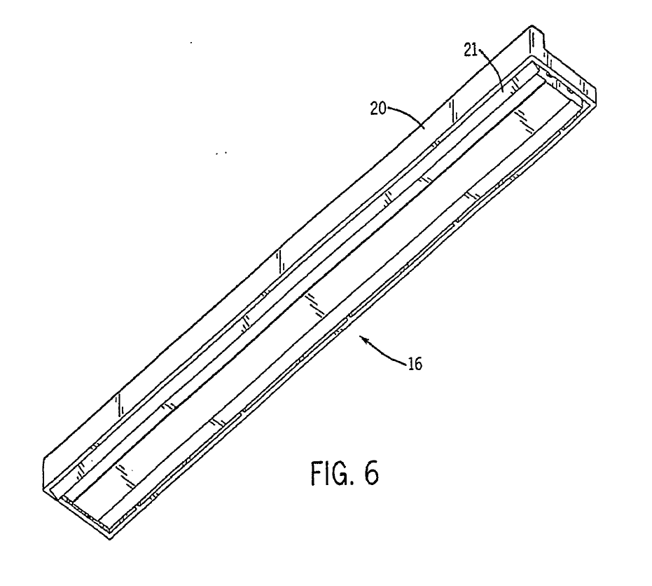

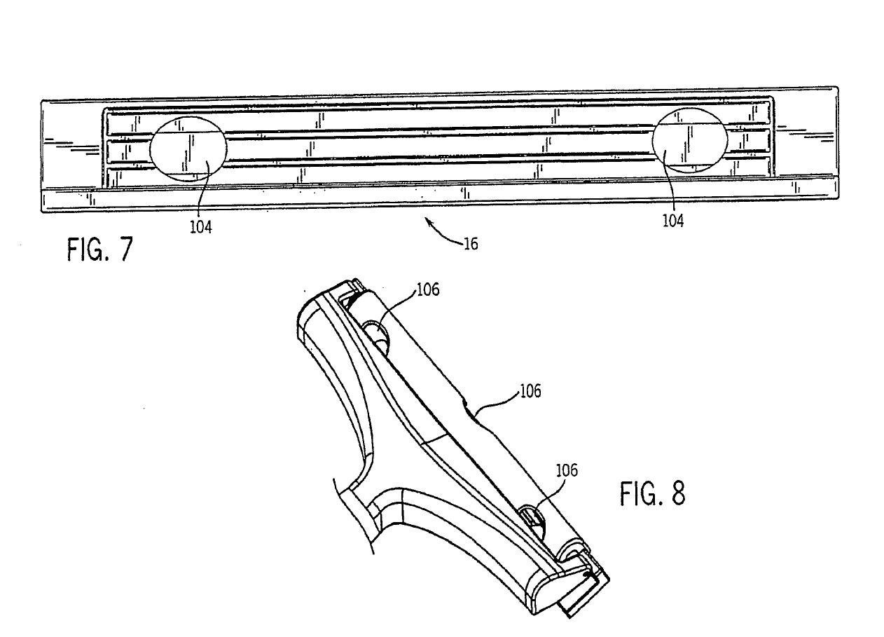

Alternatively, as shown in FIGS. 6 and 7, the outer shell 20 of the refill cartridge 16 can be formed with multiple rear holes 104. If a consumer pushes a finger through a rear hole 104, it can cause the substrate 24 to pop out of the shell 20 (notwithstanding any shell tangs), thereby facilitating replacement of the substrate 24, without needing to replace the squeegee blade (e.g. if that is not yet too worn).

Further as shown in FIGS. 1 and 8, holes 106 can be provided in the support head's 14 upper portion which allow a finger to be positioned behind the refill cartridge 16 to cause it to pop out as a unit. This facilitates removal of that subassembly, when replacement of that subassembly as a whole is desired.

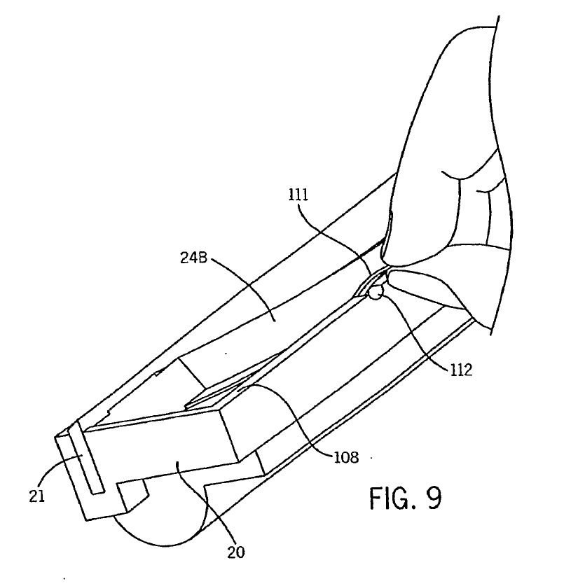

As seen in the FIG. 9 alternative embodiment, an internal cavity 108 of the shell 20 can be provided with a strap 111 which extends down from near the squeegee blade 21 behind the substrate 24B and then through a slot 112, when the substrate 24B is in the shell. A consumer can grip the strap 111 and tug it forwardly and upwardly, thereby popping the substrate 24B out without needing to touch it. When inserting a new substrate in its place, the end of the strap 111 will automatically be dragged back to its original position behind the substrate and through the slot 112.

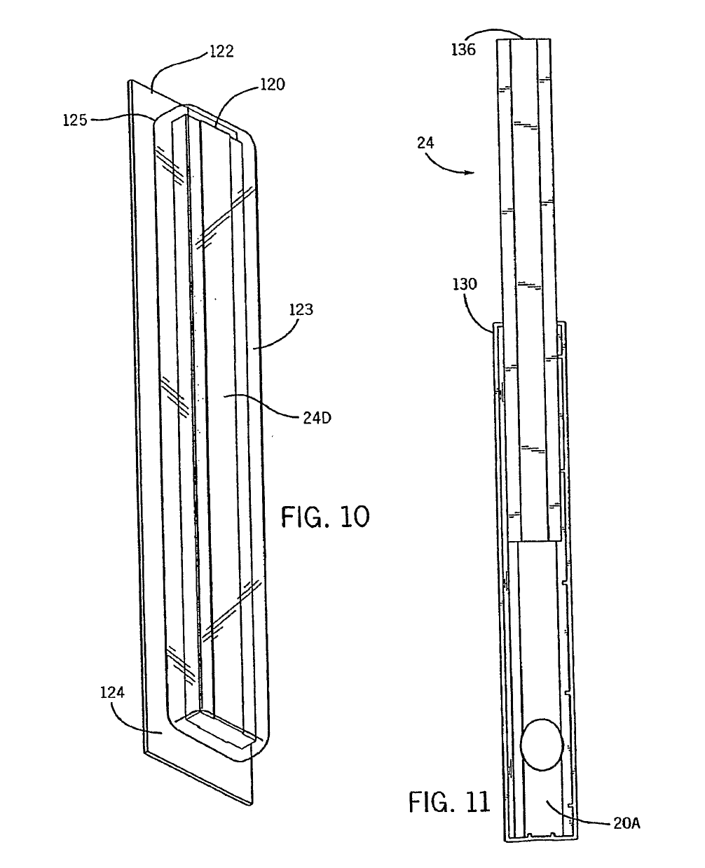

As seen in FIG. 10, a refill substrate 24D can be positioned in a flexible (preferably transparent or translucent) rectangular cup 120 having an upper flange 124. During storage and prior to use there is a peel-off cover 122 sealed against the flange 124. When a used substrate has been removed from its shell 20 and disposed of, one can remove the peel-off cover 122, align the now open end of the cup 120 with a frontally directed opening of the shell 20, and press the bottom wall 123 of the cup 120 inward.

Because of the flexibility of the cup, it can deform or flex significantly inwardly, thereby driving the substrate out of the cup 120 and past point 125, and then into shell 20, where it can be retained. A wide variety of flexible “blister” pack material, such as polyester, polyolefin and other resin plastics, should also work.

This principle can be applied to other containers than just cups (e.g. bags). Further, it is applicable to installing other replacement members than just those associated with a cleaning device of the above type.

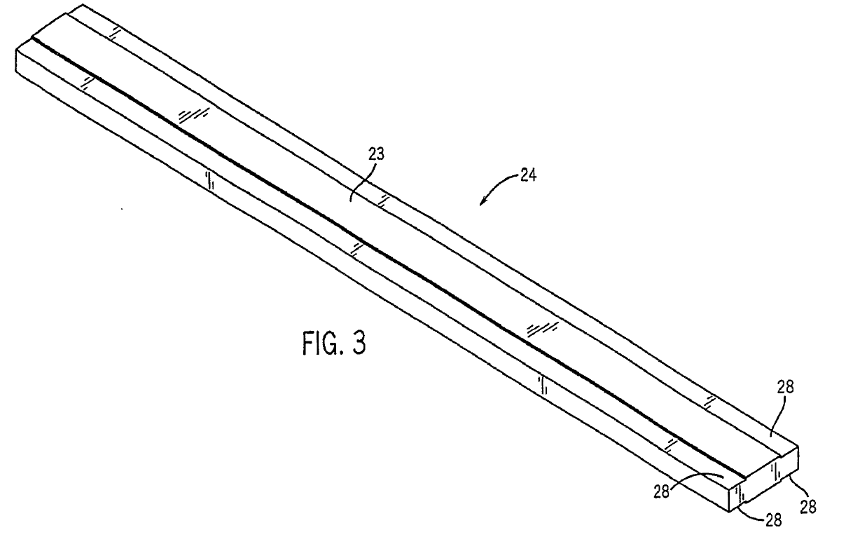

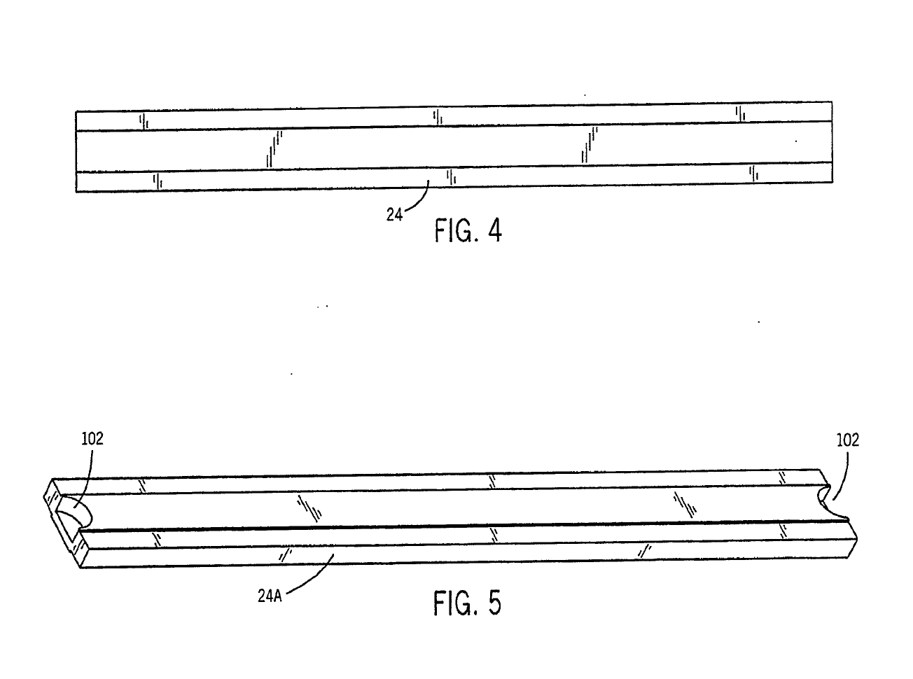

As seen in FIG. 11, instead of installing the FIG. 3 substrate by a front-to-back frictional pushing motion, the FIG. 3 substrate could instead be inserted into a side opening of a modified shell 20A. Preferably that side opening has a cross sectional opening 130 closely complementary to the FIG. 3 cross section, so as to create a tongue in groove sliding connection. If desired, there could be a nub (not shown) adjacent the end 136 of the substrate 24 that cooperates with a corresponding recess in the shell 20A to create a snap connection when the replacement substrate is fully inserted.

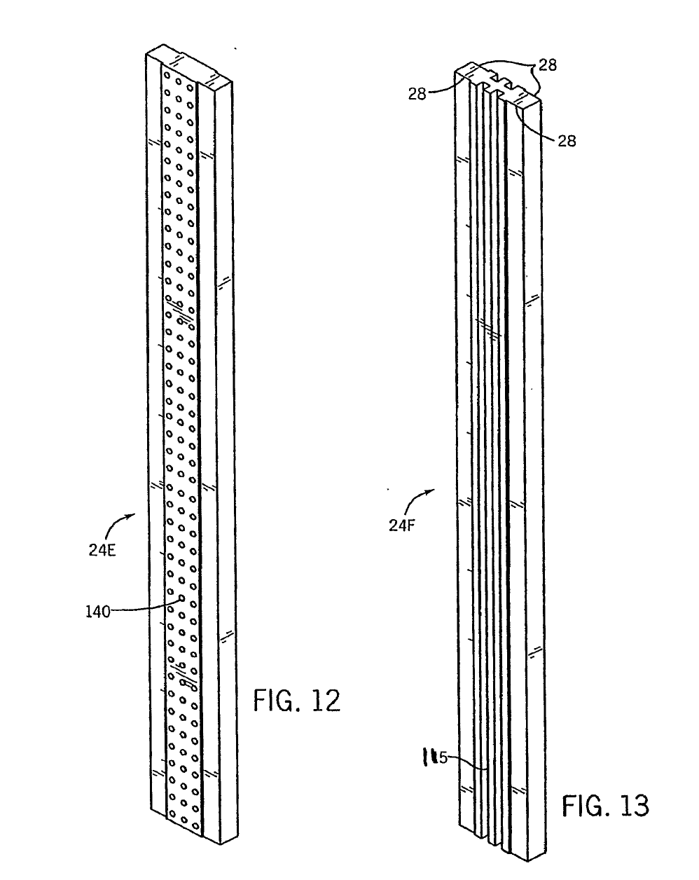

As seen in FIG. 12 a modified substrate 24E can be provided with an integral array of tiny raised nubs 140 along its contact surface. This helps remove dried material (e.g. a dead insect) from windows or the like.

As seen in FIG. 13, one can provide another modified substrate with four side-to-side grooves 115 along its contact surface, two of which are on the front, and two of which are on the back. This breaks up the contact area of the substrate 24F into three raised ribs per side. This can facilitate scrubbing and/or absorption.

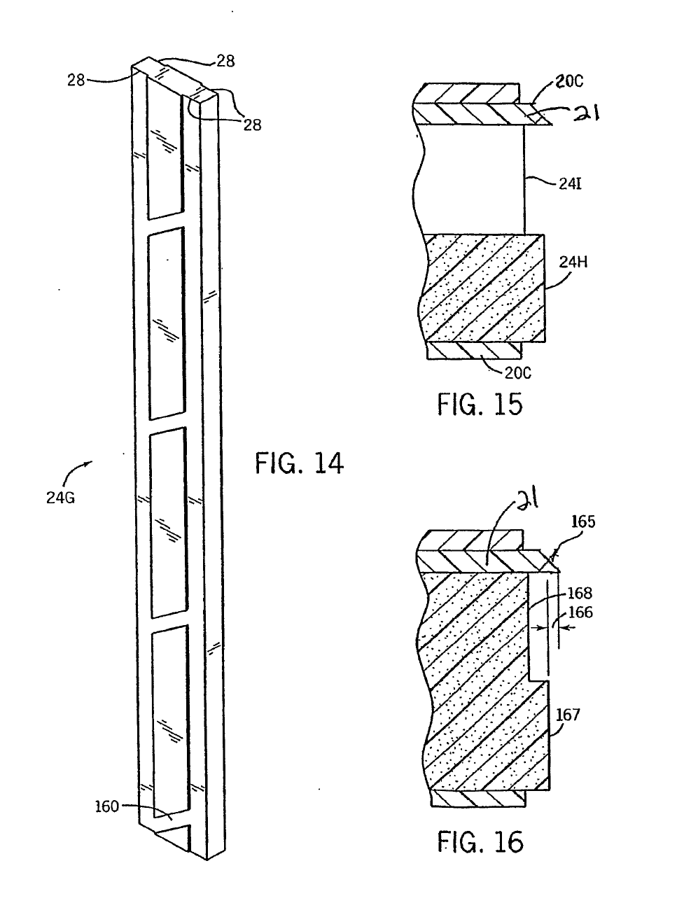

As seen in FIG. 14, the raised surfaces of substrate 24G can be broken up by diagonal grooves 160 to facilitate scrubbing and absorption.

As shown in FIG. 15, a multi-part substrate can be provided in an outer shell 20C. The lower part of the substrate 24H can be the same material preferably used for the FIG. 3 embodiment, and can be impregnated with the same types of cleaning liquids. However, a second slab of substrate material 24I closely abuts the substrate 24H. The substrate 24I can be made of a more absorbent material such as a sponge or a superabsorbent.

If desired, an impermeable plastic divider wall (not shown) can be positioned between substrates 24H and 24I to reduce mixing of used cleaning fluid with fresh cleaning fluid.

FIG. 16 shows another embodiment having preferred positioning relationships among the parts. In preferred forms the squeegee outer tip 165 extends slightly outward of the extension line 166 representing the outermost extension of the contact surface 167. If outer tip 165 of the squeegee were instead inset relative to the contact surface, the device would leave streaks absent an uncomfortable tilting of the squeegee handle. If this part of the squeegee were just about the same amount forward as the contact surface, there could still be some tendency to have incomplete squeegeeing, particularly as the squeegee begins to wear. If the squeegee tip extends too far forward of the contact surface, it can impede liquid delivery from the contact surface.

Thus, in preferred forms the substrate has an inset portion 168 and an outwardly extending contact surface 167 such that the squeegee blade outer tip 165 preferably extends farther frontally than the contact surface 167, preferably by at least 0.2 mm but not more than 2 mm (most preferably between 0.2 mm and 0.8 mm), and the squeegee blade tip 165 preferably extends farther frontally than the rearmost portion of the inset portion 168 by at least 0.5 mm, but not more than 3 mm (even more preferably between 0.8 mm and 1.5 mm).

The substrate need not be formed as a separate part relative to the squeegee blade. Rather, the squeegee blade may be formed in abutting relationship relative to the substrate by a co-extrusion process. Alternatively, co-extrusion process can form the blade where it is sandwiched on both sides by the substrate.

Such impregnated substrates are preferably very elongated so that a large area of window can be cleaned at a time. However, if a large, elongated impregnated slab of substrate happens to be stored vertically for a prolonged period, a gravitational head of the impregnating liquid may start to drive the liquid out of the substrate before the desired use, creating an undesirable drool in the refill package. One solution would be to form the substrate in several smaller pieces and mount those pieces with a gap or divider there between.

Resistance to drool can also be achieved by selecting a more viscous cleaning liquid. However, performance could be adversely affected if the contact surface of the substrate is unable to deliver sufficient amounts of the cleaning liquid to the window.

To determine a material's resistance to drooling when impregnated, a test has been developed to measure its “VP Factor”. A slab of material is mounted vertically in a test apparatus so that the lower end of the material just touches the impregnating liquid. Weight and visual properties are measured and monitored in order to determine how quickly liquid is picked up by the substrate and how quickly the liquid is wicked up along the substrate. Monitoring is conducted for a 20 second test period, with readings at each second during that period.

At each second after time zero, a reading is taken of (the flow rate into the substrate in grams/second) times (4 times the height in centimeters that the liquid has been wicked up the substrate at that time) times (the viscosity of the impregnating liquid in centipoise) times (the maximum length of the substrate in centimeters) divided by (the total volume of the substrate in cm³), and also divided by (the surface tension of the impregnating liquid in dynes times seconds). The resultant at each time is then averaged over the 20 second test period to yield an average over this period, which is defined as the “VP Factor”. The substrate has a “VP Factor” (as defined) of between 3.0×10⁻⁴ and 16×10⁻⁴, more preferably between 5×10⁻⁴ and 14×10⁻⁴, even more preferably between 7×10⁻⁴ and 12×10⁻⁴ (grams times centipoise/sec times dynes), and therefore will be resistant to drool without unnecessarily impeding cleaning properties.

Other suitable materials can be identified based on the tortuosity of the pore structure, the pore size, the permeability, and the density. For example it is preferred to have a permeability of the substrate between 14.0 and 55 darcy, more preferably between 17 and 50 darcy, even more preferably between 20 and 44 darcy. Substrates with a compressibility between 0.5 and 18 grams/mm², most preferably 2 and 15 grams/mm², even more preferably between 3 and 13 grams/mm² are most desirable. Also, porosity between 60 to 90 percent, more preferably between 70 to 85 percent, most preferably between 79 to 83 percent is the most desirable. Moreover, densities of 0.1 to 25 grams/cc are preferred.

In use, cleaning implement 10 is pressed against and pulled along a dirty window or other surface being cleaned. Squeegee blade 21 will typically be above the substrate contact surface 23. The contact surface 23 will deposit cleaning liquid on the window, and the squeegee blade 21 will then immediately scrape it off into the substrate inset 28. This used liquid will then be absorbed back into the substrate 24, and in some embodiments be filtered by the substrate and returned to the contact surface 23. Thus, a window or other hard surface can be cleaned and dried without needing any other tool or element.

When cleaning glass in particular, it is desirable that the cleaning head lay flat on the glass surface. Hence, the support head is preferably linked to the handle in a floating pivoting manner that maintains appropriate pressure distribution across the cleaning head. More pressure should be placed on the blade than the substrate during use. Hence, a location of the pivot axis on the cartridge closer to the blade end (rather than centered on the cartridge) is desirable to cause greater pressure on the blade.

The cleaning implement functions best when the substrate has contact along its entire bottom surface. This can be achieved by a housing floor of the cartridge shaped to tightly fit the substrate. For example, if the substrate were flat at its bottom, then a completely flat housing floor surface would be desired. If instead a substrate like that of FIG. 3 is used it would be desirable for the cartridge housing floor to have a complementary shape. Having full contact along the bottom surface of the substrate maintains more even pressure of the substrate on the hard surface being cleaned during use.

While preferred embodiments of the present invention have been described and otherwise disclosed in the drawings, alternative embodiments are also intended to be within the scope of the invention protected hereby. For example, the refill cartridge may be designed to be mountable in a pivotable fashion to the support head, rather than in a fixed fashion. Further, the squeegee blade need not be part of the cartridge 16. It may be permanently affixed to the support head.

In other alternatives the rear of the support head may be provided with an additional tool such as a hard scraper blade or sponge, the side-to-side dimension of the head size may be varied to accommodate very small windows or very large windows, and the impregnation fluid may be varied to include other properties besides cleaning features (e.g. antibacterial).

In still other forms the absorbent portion of the refill may be a stack of cellulosic sheets, where a soiled sheet can be ripped off the stack when full, or other highly absorbent materials such as sponge or high-loft non-woven material may be used as the absorbent.

Hence, the inventions disclosed herein are not to be limited to the preferred embodiments.

### INDUSTRIAL APPLICABILITY

The present invention provides all-in-one cleaning devices for cleaning windows and other surfaces, with particular emphasis on improved refills for use therewith.

1. A refill for a cleaning implement, the cleaning implement being of a type suitable to clean a hard surface, the refill comprising:
a porous substrate impregnated with a cleaning liquid and suitable to be mounted on the cleaning implement;
wherein the substrate has a frontal face with two inset portions and an outwardly extending contact portion there between; and
wherein the refill can present an essentially identical face to the hard surface regardless of whether mounted on the cleaning implement in a first orientation, or in a second orientation upside down from the first orientation.

2. The refill of claim 1, wherein:
the substrate also has a back face with two inset portions and an outwardly extending contact portion there between; and
wherein the refill can present an essentially identical face to the hard surface regardless of whether mounted on the cleaning implement in the first orientation, or in the second orientation, or in a third orientation front-to-back reversed relative to the first orientation, or in a fourth orientation front-to-back reversed relative to the second orientation.

3. The refill of claim 1, wherein the substrate has a frontal face with two lateral inset portions suitable to facilitate gripping of the refill and removal of the refill from the cleaning implement.

4. A refill cartridge for an implement suitable to treat a hard surface, the cartridge comprising:
a housing; and
a porous substrate mounted to the housing, wherein the substrate is impregnated with a liquid and the substrate is suitable to deliver the liquid to the surface as well as to collect used liquid;
wherein the housing is provided with means to facilitate removal of the porous substrate from the housing.

5. The refill cartridge of claim 4, wherein said means comprises a rear opening through the housing such that by passing something through the opening one can facilitate removal of the porous substrate from the housing.

6. The refill cartridge of claim 4, wherein said means comprises a strap extending in the housing behind the substrate and also externally of the cartridge, whereby pulling on the strap can facilitate removal of the substrate from the housing.

7. (canceled)

8. (canceled)

9. The refill of claim 1
wherein the substrate has a frontal contact face provided with means on its surface to present an abrasive contact surface.

10. The refill of claim 9, wherein the means is an array of raised bumps.

11. The refill of claim 9, wherein the means is an array of ribs.

12. The refill of claim 9, wherein the means is at least one diagonal groove separating two areas of an abrasive contact surface.

13. (canceled)

14. (canceled)

15. (canceled)

16. A refill for a cleaning implement, the cleaning implement being of a type suitable to clean a hard surface, the refill comprising:
a porous substrate impregnated with a cleaning liquid and suitable to be mounted on the cleaning implement;
wherein the substrate has a characteristic selected from the group consisting of a VP Factor of between 3×10⁻⁴ and 16×10⁻⁴, a permeability of between 14 and 55 darcy, a Compressibility of between 0.5 and 18 g/mm², a density of between 0.01 and 25 g/cc, and a porosity of between 60 and 90 percent.
